(19) United States
(12) Patent Application Publication
(10) Pub. No.: US 2006/0049302 A1
(43) Pub. Date: Mar. 9, 2006

(54) Apparatus and methods for structurally-integrated conductive conduits for rotor blades

(76) Inventors: Dennis K. Kennedy, Mesa, AZ (US); Friedrich K. Straub, Mesa, AZ (US); Robert J. Murrill, Gilbert, AZ (US)

Correspondence Address: BLACK LOWE & GRAHAM PLLC, 701 FIFTH AVENUE, SUITE 4800, SEATTLE, WA, 98104, US

(21) Appl. No.: 10/930,478

(22) Filed: Aug. 31, 2004

(51) Int. Cl. B64C 27/00

(52) U.S. Cl. 244/17.11

(57) ABSTRACT

Structurally-integrated conductive conduits for rotor blades are disclosed. In one embodiment, an elongated rotor blade includes a body having a root portion and a distal portion spaced apart from the root portion, a device coupled to the body, and a conduit assembly disposed within the body and extending between the root portion and the device. The conduit assembly includes a main body assembly having at least one of a conductive lead, a fluid line, and an optical fiber disposed within a matrix material, the conduit assembly extending from the root portion to the device. In alternate embodiments, the device may comprise an actuator, a smart actuator, a piezoelectric material, an electromagnetic device, an electromechanical device, a hydraulic actuator, a pneumatic actuator, a light, and a sensor.

### STATEMENT OF GOVERNMENT INTEREST

This invention was made with government support under U.S. Government Contract NAS2-01064 awarded by the National Aeronautics and Space Administration. The U.S. Government has certain rights in this invention.

### FIELD OF THE INVENTION

The present disclosure relates to rotor/wing aircraft, and more specifically, to apparatus and methods for structurally-integrated conductive conduits for rotor blades.

### BACKGROUND OF THE INVENTION

Active control of rotor blades with the goal of reducing rotor born noise and vibration is an ongoing area of research in the helicopter and rotor-driven aircraft industry. Numerous research papers and scale model tests have predicted and demonstrated the successful reduction of airframe vibration levels and noise through a number of enabling schemes. One such scheme is active control of a hinged trailing edge flap(s) located near the blade tip of a rotor blade. The location and number of flaps relative to the blade tip can affect both the blade vibration level due to the inherent unsteady aerodynamic conditions and the noise generated at the blade tip due to blade vortex interactions depending on the configuration selected.

Successful “on blade” active control rotor systems rely on actuation means to drive the flap. Piezoelectric smart materials are currently being investigated as an actuation means by university, government, and industry-sponsored research. For example, embedded piezoelectric sheets are being investigated as a means to control trailing edge elevons. Embedded piezoelectric fibers are also being investigated to allow dynamic twist variation of a rotor blade. Alternately, discrete piezoelectric actuators coupled with actively controlled rotor blade flaps are disclosed, for example, U.S. Pat. No. 6,135,713 issued to Domzalski et al., U.S. Pat. No. 5,907,211 issued to Hall et al., and U.S. Pat. No. 5,224,826 issued to Hall et al.

Although desirable results have been achieved, technical difficulties have been encountered. For example, traditional surface mount techniques for providing actuator power and for transmitting signals along the rotor blade may be adversely impacted by the extremely hostile vibratory and high g-field environment on the rotor blade and its components. These effects may reduce the usable life of such systems below acceptable levels due to excessive fatigue. Such systems may also undesirably degrade the structural and aerodynamic characteristics of the rotor blade.

Furthermore, efforts directed toward providing power and data signals to embedded piezoelectric actuators in rotor blades generally involve running wiring along a spanwise groove formed within the blade surface as disclosed, for example, in Full Scale Rotor with Piezoelectric Actuated Blade Flaps, 28^{th} European Rotorcraft Forum, Session Dynamics 7, Paper 89, pg 89.7 by Enenkl et al. Additional efforts to develop a more advanced electrical bus system for directing electric power and data or control signals to embedded piezoelectric elements within the rotor blade have shown that low temperature solder joints may be degraded during blade assembly cure operations. Therefore, novel apparatus and methods which at least partially mitigate these undesirable characteristics would be useful.

### SUMMARY OF THE INVENTION

The present invention is directed to apparatus and methods for structurally-integrated conductive conduits for rotor blades. Apparatus and methods in accordance with the present invention may advantageously provide the ability to transmit power and data signals along a rotor blade to embedded actuators or other devices in a manner that mitigates the effects of high fatigue cyclic strain levels on conductive elements, and that allows the mass and stiffness of the structurally-integrated conductive element assembly to be tailored to achieve the desired blade aeroelastic properties.

In one embodiment, an elongated rotor blade includes a body having a root portion and a distal portion spaced apart from the root portion, a device coupled to the body, and a conduit assembly disposed within the body and extending between the root portion and the device. The conduit assembly includes a main body assembly having at least one of a conductive lead, a fluid line, and an optical fiber disposed within a matrix material, the conduit assembly extending from the root portion to the device. In alternate embodiments, the device may comprise an actuator, a smart actuator, a piezoelectric material, an electromagnetic device, an electromechanical device, a light, and a sensor.

### BRIEF DESCRIPTION OF THE DRAWINGS

Preferred and alternative embodiments of the present invention are described in detail below with reference to the following drawings.

FIG. 1 is an isometric view of a rotor blade in accordance with an embodiment of the present invention;

FIG. 2 is an end cross-sectional view of the rotor blade of FIG. 1 taken along line 2-2;

FIG. 3 is an is an enlarged elevational view of the distal coupling assembly within the cavity of the rotor blade of FIG. 1;

FIG. 4 is an enlarged elevational view of a power connector of the distal coupling assembly of FIG. 3;

FIG. 5 is an enlarged isometric view of a root portion of the rotor blade of FIG. 1;

FIG. 6 is an isometric view of a helicopter having a rotor blade in accordance with an embodiment of the present invention; and

FIG. 7 is an isometric view of a rotor aircraft having a rotor blade in accordance with another embodiment of the present invention.

### DETAILED DESCRIPTION OF THE INVENTION

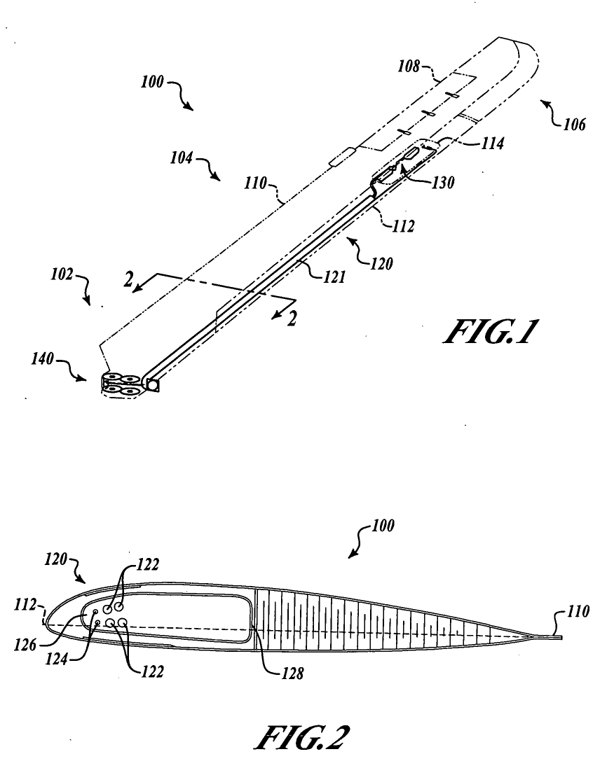

The present invention relates to apparatus and methods for structurally-integrated conductive conduits for rotor blades. Many specific details of certain embodiments of the invention are set forth in the following description and in FIGS. 1-7 to provide a thorough understanding of such embodiments. One skilled in the art, however, will understand that the present invention may have additional embodiments, and that the present invention may be practiced without several of the details described in the following description.

In general, embodiments of structurally-integrated conductive conduits for rotor blades in accordance with the present invention provide the ability to transmit power and data signals along a rotor blade to embedded actuators, sensors, or other devices in a manner that at least partially mitigates the above-noted disadvantages of conventional electrical systems. For example, as described more fully below, embodiments of the present invention may minimize the effects of high fatigue cyclic strain levels on conductive elements to achieve a longer fatigue life, and may allow the tailoring of the mass and stiffness of the structurally-integrated conductive element assembly to achieve the desired rotor blade aeroelastic properties.

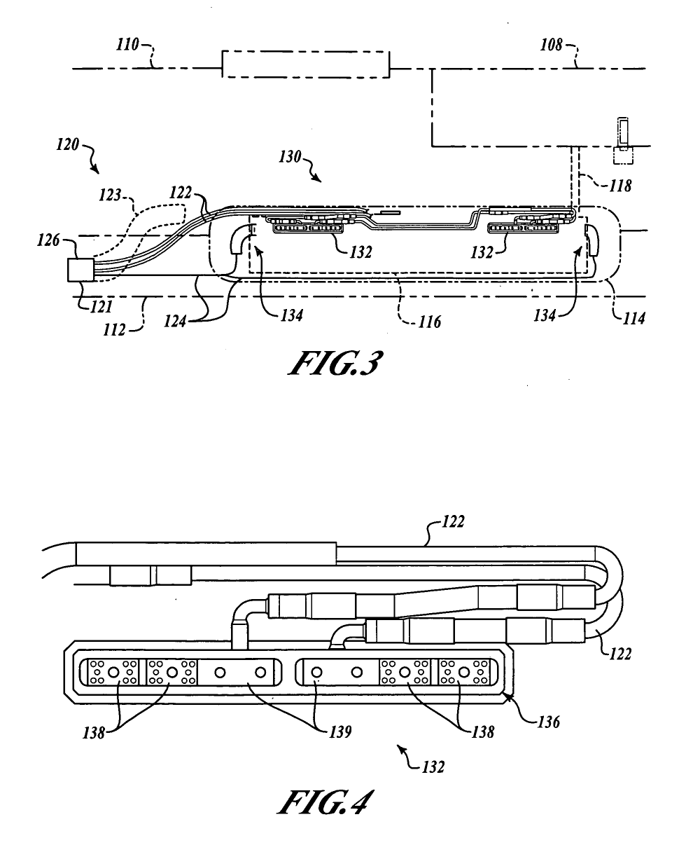

More specifically, FIG. 1 is an isometric view of a rotor blade 100 in accordance with an embodiment of the present invention. FIG. 2 is an end cross-sectional view of the rotor blade 100 of FIG. 1 taken along line 2-2. In this embodiment, the rotor blade 100 includes a root portion 102, an elongated body portion 104, and a tip portion 106. A controllable flap 108 is formed along a trailing edge 110 proximate the tip portion 106, and a structurally-integrated conductive conduit 120 extends through the root portion 102 and at least partially through the body portion 104 proximate a leading edge 112 of the rotor blade 100. The conductive conduit 120 includes a distal coupling assembly 130 disposed within a cavity 114, and a root coupling assembly 140 disposed within the root portion 102 of the rotor blade 100.

As best shown in FIG. 2, the conductive conduit 120 includes a plurality of power leads 122 and a plurality of data leads 124 disposed in a matrix material 126. The leads 122, 124 and matrix material 126 form a main assembly body 121. In some embodiments, the power leads 122 and the data leads 124 may be insulated and shielded stranded copper wires molded into the matrix material 126. In FIG. 2, the conductive conduit 120 is positioned between a spar 128 and the leading edge 112.

A wide variety of matrix materials may be used to form the conductive conduit 120 including, for example, thermosetting resins such as epoxies, polyimides, and phenolics, or thermoplastic resins such as PEI and PEEK. The choice of resin may be limited by the manufacturing processing temperature limits of the selected embedded conductive lead (e.g. wire insulation type), fluid line or optical fiber, etc. Composite matrix fiber materials including, for example, glass, carbon, Kevlar or metallic fibers, etc. in a number of forms, such as continuous rovings or tape, woven mats, discontinuous, chopped, wire or whiskers, etc. can also be used as a matrix material. In one particular embodiment, the matrix material comprises a chopped fiberglass in an epoxy resin. In alternate embodiments, the conductive conduit 120 may support the embedded lead(s) using a matrix resin only, without a reinforcing matrix fiber.

It will be appreciated that the conductive conduit 120 may be fabricated in any one of a number of conventional composite molding or processing techniques; such as, room temperature pour and casting, prepreg hand lay-up and autoclave or press curing, injection molding methods, resin transfer molding, or any other suitable process. The processing method may be a function of the matrix material selected and the embedded conductive lead material, which may impose processing constraints

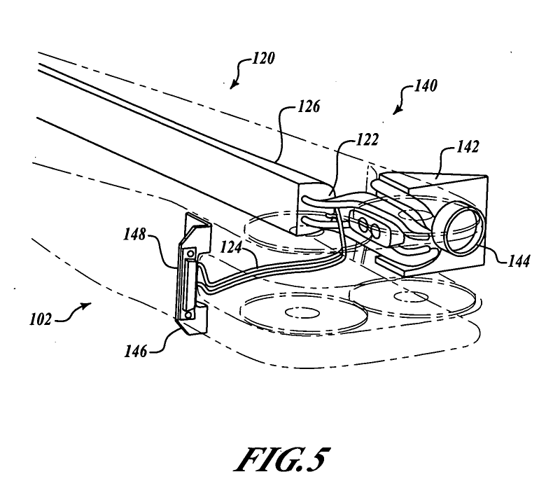

FIG. 3 is an enlarged elevational view of the distal coupling assembly 130 within the cavity 114 of the rotor blade of FIG. 1. In this embodiment, the distal coupling assembly 130 includes a power supply connector 132 coupled to an end of each of the power leads 122, and a data connector 134 coupled to the end of each of the data leads 124. The power supply connectors 132 and the data connectors 134 are coupled to an actuator 116 (or other suitable drive mechanism) disposed within the cavity 114 which is, in turn, operatively coupled to the flap 108 by a coupling member 118. The power supply connectors 132 may include conventional components, such as ITT connector MJSB-10PL2. As shown in FIG. 4, the power supply connectors 132 may include a housing 136 that encloses a plurality of connectors 138 and a plurality of terminals 139 that are coupled to the power leads 122.

It will be appreciated that the main assembly body 121 of the conductive conduit 120 may be adapted to suit a particular installation or a particular set of interface requirements. For example, as shown in FIG. 3, in an alternate embodiment, an outboard end 123 of the main assembly body 121 may be geometrically reconfigurable to suit a variety of actuator installations, sensor positions, and interface requirements.

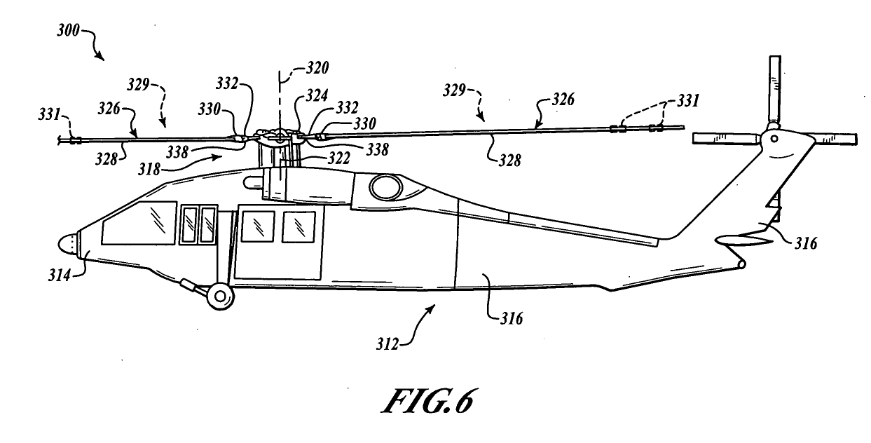

FIG. 5 is an enlarged isometric view of the root portion 102 of the rotor blade 100 of FIG. 1. In this embodiment, the root coupling assembly 140 includes a first bracket 142 attached to a master power supply connector 144, and a second bracket 146 attached to a master data connector 148. The power leads 122 are operatively coupled to the master power supply connector 144, and the data leads 124 are operatively coupled to the master data connector 148. The components of the root coupling assembly 140 may be standard commercial off the shelf (COTS) components specifically designed to meet the internal packaging space and loading constraints of the rotor blade environment. In various embodiments, the first and second brackets 142, 146 may be conventional brackets. Similarly, the connectors 144, 148 may be conventional connectors.

Although the conductive conduit 120 shown in FIGS. 1-5 has coupling assemblies 130, 140, that are depicted as being separate of the main assembly body 121, alternate embodiments can be conceived that integrate the coupling assemblies 130, 140 into the main assembly body 121 at the root and distal ends. Similarly, in further embodiments, the power and data terminations of the root and distal coupling assemblies 130, 140 need not be separate entities, but rather, may be combined into a single termination member.

In operation, electrical power may be provided through the master power connector 144 and the power leads 122 of the conductive conduit 120 to the actuator 116. Similarly, control signals and data signals may be transmitted to and received from the actuator 116 via the data leads 124 and the master data connector 148. Thus, using a suitable controller (e.g. a portion of the flight control system of the rotor-driven aircraft), the actuator 116 may be controllably driven to actuate the flap 108 into a desired position, such as to reduce vibration of the rotor blade 100.

Embodiments of structurally-integrated conductive conduits for rotor blades in accordance with the present invention may provide considerable advantages over the prior art. For example, embodiments of the present invention may minimize the effects of high fatigue cyclic strain levels on conductive elements. Because the power leads 122 and the data leads 124 are disposed within the matrix material 126, the fatigue on these conductive elements is reduced and a longer fatigue life may be achieved. Also, the positioning of the leads 122, 124 within the matrix material may allow the tailoring of the mass and stiffness of the structurally-integrated conductive element assembly to achieve the desired rotor blade aeroelastic properties. In other words, by proper selection and formation of the matrix material 126, the structural properties of the rotor blade 100 may be improved in comparison with the prior art. The material properties of the conductive leads in the matrix material may be selected and tailored to provide optimum electrical characteristics and blades stiffness properties when installed and bonded within the rotor blade structure. Furthermore, the integrated design of the conductive conduit 120 with the rotor blade structure geometrically can place the internal wiring as close to the blade flap-wise neutral axis as possible to minimize the effects of high flap bending cyclic strain levels on the embedded conductive elements to achieve a longer fatigue life.

When tailoring the conductive conduit 120 to transmit high-voltage electric power, the use of shielded, single conductor or multi-conductor stranded wire insulated cable allows the use of high-voltage power from noisy sources, such as switching amplifiers, in close proximity to low-voltage instrumentation data signals, in which it is desired to minimize the effects of electrical noise. The ability to place power and data signal conductive leads in close proximity, while selecting the matrix material, allows the tailoring of the mass and stiffness of the conductive conduit 120 to the overall desired blade aeroelastic properties.

It will be appreciated that a variety of alternate embodiments of apparatus and methods in accordance with the present invention may be conceived, and that the invention is not limited to the particular embodiments described above and shown in FIGS. 1-5. for example, an alternate embodiments, additional leads 122, 124 may be embedded in the matrix material 126 of the conductive conduit 120 to provide a means for blade section balance, or to provide built-in spare leads or growth capacity. Also, discrete distributed masses of the suitable material may be molded into the matrix material 126 of the conductive conduit 120 to provide another means for blade section balance.

Furthermore, alternate embodiments of conductive conduits in accordance with the present invention may be adapted to provide power and data signals to any other desired type of component that may be embedded within or affixed to the rotor blade 100. For example, in alternate embodiments, conductive conduits in accordance with the present invention may be adapted to operate in conjunction with other smart material actuation technologies, including, for example, smart actuators based on magnetostrictive materials and shape memory alloys as generally disclosed in U.S. Pat. No. 6,322,324 issued to Kennedy et al., and in U.S. Pat. No. 6,453,669 issued to Kennedy et al., which patents are incorporated herein by reference. Still further embodiments may be adapted to operate with other methods of on-blade control to influence aerodynamic forces on rotor blades, including deployable leading edge devices, and active flow control using Lorentz force (voice coil) actuators of the type generally disclosed, for example, in U.S. Pat. No. 5,938,404 issued to Domzalski et al. In addition, embodiments of the present invention may be adapted to operate with a variety of conventional devices, such as electromagnetic, electromechanical, and hydraulic devices. For example, one or more of the power leads 122 of the conductive conduit 120 may be replaced with a hydraulic or pneumatic supply line to actuate conventional hydraulic or pneumatic actuators.

Alternate embodiments the present invention may also be used to provide power and/or signals to other on-blade devices, including sensors (e.g. strain gauge devices, accelerometers), lights, or any other suitable devices. Furthermore, one or more of the power leads or data leads may be replaced with an optical fiber for transmitting optical signals to and from an optically-based blade-mounted device.

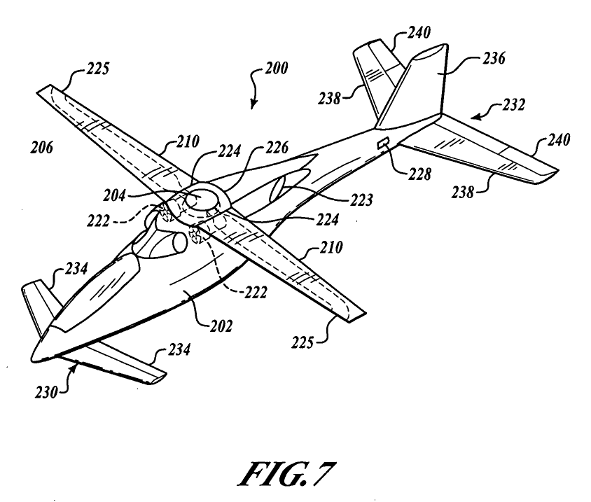

Embodiments of apparatus and methods for structurally-integrated conductive conduits for rotor blades in accordance with the present invention may be utilized on a wide variety of rotor-driven aircraft. For example, FIG. 6 is an isometric view of a helicopter 300 having a plurality of rotor blade assemblies 326 in accordance with an embodiment of the present invention. The helicopter 300 includes a fuselage 312 which extends from a front end 314 to a tail section 316. A main rotor assembly 318 extends out of the fuselage 312 and defines an axis of rotation 320. The main rotor assembly 318 includes a main rotor shaft 322 and a main upper hub assembly 324. A plurality of main rotor blade assemblies 326 are coupled to the main rotor assembly 318 and particularly the main upper hub assembly 324.

As further shown in FIG. 6, each of the main rotor blade assemblies 326 comprises a blade member 328 having a conductive conduit 329 in accordance with the present invention. A plurality of devices 331 are coupled to the blade members 328 and are operatively coupled to the conductive conduits 329 as described above. A pitch case 330 of the main rotor blade assembly 326 is coupled to the main upper hub assembly 324 at its root end 332. More specifically, each blade member 328 is pinned or otherwise coupled to the pitch case 330 through a plurality of fasteners (not shown), such as quick release pins. A flexible joint type connection 338 is used to connect each of the pitch cases 330 to the main upper hub assembly 324. A conventional slip ring assembly (not visible) may be used to transmit power and data from the non-rotating to the rotating portions of the hub assembly. Except for the novel rotor blade assemblies 326 in accordance with the present invention, the components and operation of the helicopter 300 are generally known and are described more fully, for example, in U.S. Pat. No. 5,951,252 issued to Muylaert, which patent is incorporated herein by reference.

As described above, the devices 331 on the blade members 328 may be any type of device that requires power or that transmits or receives data signals, including, for example, a light, a sensor (e.g. strain gauge, accelerometer, thermocouple, temperature gauge, etc), a smart material (e.g. a piezoelectric material, magnetostrictive material, a shape memory alloy, etc.), an electromagnetic or electromechanical device, or any other suitable device. Alternately, the devices 331 may be a hydraulic or pneumatic device coupled to hydraulic or pneumatic lines disposed within the conductive conduit 329, or an optically-based device coupled to an optical fiber disposed within the conductive conduit 329. Of course, in further embodiments, the blade member 328 may include a flap, and one or more of the devices 331 may be an actuator or other drive mechanism, as described above with respect to FIGS. 1-5.

FIG. 7 is an isometric view of a rotor aircraft 200 having rotor blades 210 in accordance with another embodiment of the present invention. In this embodiment, the aircraft 200 includes a fuselage 202, on which is rotatably mounted a rotor hub 204. Attached to the hub 204 is a rotor 206 including a pair of blades 210 having structurally-integrated conductive conduits 220 in accordance with the present invention. Each conductive conduit 220 extends from approximately the hub 204 to a device 216 coupled to the blade 210 proximate a distal end thereof. As described above, the devices 216 on the blade 210 may be any type of devices that require power or that transmit or receive data signals, or any type of hydraulic, pneumatic, or optically-based devices coupled to an optical fiber disposed within the conductive conduit 220.

As further shown in FIG. 7, in this embodiment, the rotor aircraft 200 is powered by a pair of low bypass turbofan engines 222. Exhaust gases from the engines 222 are exhausted through nozzles 223 and through tip jets 225 disposed at the outer ends of the rotor blades 210 that provide reaction drive rotor control, as described more fully, for example, in U.S. Pat. No. 5,454,530 issued to Rutherford et al., which patent is incorporated herein by reference. In order to control aircraft flight, the rotor hub 204 may be of the gimbaled/teetering type in order to allow flapping degrees of freedom. A pair of feathering hinges 224 permit changing of the pitch of each rotor blade 210 as with a conventional helicopter. The rotor controls may include cyclic and collective pitch controllers of known construction contained within an aerodynamic hub fairing 226 that provide control capability. Similarly, yaw control may be achieved through conventional helicopter control devices, such as a tail rotor, fenestron (or “fan-in-fin”), or a thruster 228.

The aircraft 200 further includes a canard 230 and a tail assembly 232. The canard 230 extends outwardly from each side of the fuselage 202, forwardly of the rotor 206. The trailing edges of the canard 230 include flaperons 234. The tail assembly 232 is conventional with respect to other fixed wing aircraft, and includes a vertical tail portion 236 as well as two horizontal portions 238 extending outwardly from each side of the fuselage 202, rearwardly of the rotor 206. Each of the horizontal portions 238 also includes a flaperon 240.

It should be understood that the invention is not limited to the particular embodiments of rotor blades described above and shown in the accompanying figures, and that a wide variety of blade shapes may be conceived in accordance with the teachings of the present disclosure. More specifically, a wide variety of blades may be conceived having differing degrees of camber, aspect (thickness over chord) ratio, size, or other desired design parameters, and that vary from the representative blades shown in the accompanying figures.

It will also be appreciated that a wide variety of rotor driven aircraft may be conceived that include rotor blades having a structurally-integrated conductive conduit in accordance with alternate embodiments of the present invention, and that the invention is not limited to the particular aircraft embodiments described above and shown in FIGS. 6 and 7. The inventive apparatus disclosed herein may be employed in any other type of rotor aircraft, including, for example, those manned and unmanned rotor aircraft shown and described in Jane's All the World's Aircraft published by Jane's Information Group of Coulsdon, Surrey, United Kingdom, and The Illustrated Encyclopedia of Military Aircraft written by Enzo Angelucci and published by Book Sales Publishers, Inc.

While preferred and alternate embodiments' of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. An elongated rotor blade, comprising:
a body having a root portion and a distal portion spaced apart from the root portion;
a device coupled to the body; and
a conduit assembly disposed within the body and extending between the root portion and the device, the conduit assembly including a main body assembly having at least one of a conductive lead, a fluid line, and an optical fiber disposed within a matrix material, the conduit assembly extending from the root portion to the device.

2. The elongated rotor blade of claim 1, wherein the device comprises an actuator, and wherein the rotor blade further comprises a flap moveably coupled to the body proximate the distal portion, the actuator being operatively coupled to the flap and adapted to move the flap.

3. The elongated rotor blade of claim 1, wherein the device is coupled to the body proximate the distal portion.

4. The elongated rotor blade of claim 1, wherein the device comprises at least one of an actuator, a smart actuator, a piezoelectric material, an electromagnetic device, an electromechanical device, a hydraulic actuator, a pneumatic actuator, a light, and a sensor.

5. The elongated rotor blade of claim 1, wherein at least one conductive lead comprises a plurality of conductive leads.

6. The elongated rotor blade of claim 5, wherein the plurality of conductive leads includes at least one high-voltage power lead and at least one low-voltage signal lead.

7. The elongated rotor blade of claim 1, wherein the body includes an elongated spar disposed therein and extending between the root portion and the distal portion, and wherein the conductive conduit is disposed proximate the spar.

8. The elongated rotor blade of claim 7, wherein the body includes a leading edge and a trailing edge, and wherein the conductive conduit is disposed between the spar and the leading edge.

9. The elongated rotor blade of claim 1, wherein the matrix material comprises at least one a thermosetting resin, a thermoplastic resin, a material including one or more fibers, a chopped fiberglass in an epoxy resin, and a matrix resin without a reinforcing matrix fiber.

10. An elongated rotor blade, comprising:
a body having a root portion and a distal portion spaced apart from the root portion;
a device coupled to the body; and
a conductive conduit disposed within the body and extending between the root portion and the device, the conductive conduit having at least one conductive lead formed within a matrix material, the conductive lead being adapted to transmit at least one of power and data signals between the root portion and the device.

11. The elongated rotor blade of claim 10, wherein the device comprises an actuator, and wherein the rotor blade further comprises a flap moveably coupled to the body proximate the distal portion, the actuator being operatively coupled to the flap and adapted to move the flap.

12. The elongated rotor blade of claim 10, wherein the conduit assembly includes a distal coupling assembly coupled to the device.

13. The elongated rotor blade of claim 10, wherein the device comprises at least one of an actuator, a smart actuator, a piezoelectric material, an electromagnetic device, an electromechanical device, a hydraulic actuator, a pneumatic actuator, a light, and a sensor.

14. The elongated rotor blade of claim 10, wherein at least one conductive lead comprises a plurality of conductive leads.

15. The elongated rotor blade of claim 10, wherein the body includes an elongated spar disposed therein and extending between the root portion and the distal portion, and wherein the conductive conduit is disposed proximate the spar.

16. The elongated rotor blade of claim 10, wherein the matrix material comprises at least one of a thermosetting resin, a thermoplastic resin, a material including one or more fibers, a chopped fiberglass in an epoxy resin, and a matrix resin without a reinforcing matrix fiber.

17. An aircraft, comprising:
a fuselage; and
a propulsion system operatively coupled to the fuselage and including a rotor having at least one elongated blade for generating aerodynamic lift, the elongated blade including:
a body having a root portion and a distal portion spaced apart from the root portion;
a device coupled to the body; and
a conduit assembly disposed within the body and extending between the root portion and the device, the conduit assembly including a main body assembly having at least one of a conductive lead, a fluid line, and an optical fiber disposed within a matrix material, the conduit assembly extending from the root portion to the device.

18. The aircraft of claim 17, wherein the device comprises an actuator, and wherein the rotor blade further comprises a flap moveably coupled to the body proximate the distal portion, the actuator being operatively coupled to the flap and adapted to move the flap.

19. The aircraft of claim 17, wherein the conduit assembly includes a distal coupling assembly coupled to the device.

20. The aircraft of claim 17, wherein the device comprises at least one of an actuator, a smart actuator, a piezoelectric material, an electromagnetic device, an electromechanical device, a hydraulic actuator, a pneumatic actuator, a light, and a sensor.

21. The aircraft of claim 17, wherein the at least one conductive lead comprises a plurality of conductive leads.

22. The aircraft of claim 17, wherein the body includes an elongated spar disposed therein and extending between the root portion and the distal portion, and wherein the conductive conduit is disposed proximate the spar.

23. The aircraft of claim 17, wherein the matrix material comprises at least one of a thermosetting resin, a thermoplastic resin, a material including one or more fibers, a chopped fiberglass in an epoxy resin, and a matrix resin without a reinforcing matrix fiber.

24. A method of operating a rotor driven aircraft, comprising:
providing an elongated blade operatively coupled to a fuselage, the elongated blade including a body having a root portion and a distal portion spaced apart from the root portion;
providing a conduit assembly disposed within the body and extending between the root portion and a device coupled to the elongated blade and spaced apart from the root portion, the conduit assembly including a main body assembly having at least one of a conductive lead, a fluid line, and an optical fiber disposed within a matrix material, the conduit assembly extending from the root portion to the device;
rotating the elongated blade to produce an aerodynamic lifting force; and
providing at least one of electrical power, low-voltage signals, hydraulic pressure, pneumatic pressure, and optical signals through the conduit assembly to the device.

25. The method of claim 24, wherein providing at least one of electrical power, low-voltage signals, hydraulic pressure, pneumatic pressure, and optical signals through the conduit assembly to the device comprises providing at least one of electrical power, low-voltage signals, hydraulic pressure, pneumatic pressure, and optical signals through the conduit assembly to an actuator operatively coupled to the flap and adapted to move the flap.

26. The method of claim 24, wherein providing at least one of electrical power, low-voltage signals, hydraulic pressure, pneumatic pressure, and optical signals through the conduit assembly to the device comprises providing at least one of electrical power, low-voltage signals, hydraulic pressure, pneumatic pressure, and optical signals through a distal coupling assembly coupled to the device.

27. The method of claim 24, wherein providing at least one of electrical power, low-voltage signals, hydraulic pressure, pneumatic pressure, and optical signals through the conduit assembly to the device comprises providing at least one of electrical power, low-voltage signals, hydraulic pressure, pneumatic pressure, and optical signals through the conduit assembly to at least one of an actuator, a smart actuator, a piezoelectric material, an electromagnetic device, an electromechanical device, a hydraulic actuator, a pneumatic actuator, a light, and a sensor.

28. The method of claim 24, wherein providing a conduit assembly includes providing a conduit assembly having a plurality of conductive leads disposed within the matrix material.

29. The method of claim 24, wherein the matrix material comprises at least one of a thermosetting resin, a thermoplastic resin, a material including one or more fibers, a chopped fiberglass in an epoxy resin, and a matrix resin without a reinforcing matrix fiber.

30. The method of claim 24, wherein providing a conduit assembly includes providing a conduit assembly disposed proximate a spar.
